(19) United States
(12) Patent Application Publication
(10) Pub. No.: US 2024/0179607 A1
(43) Pub. Date: May 30, 2024

(54) COMMUNICATION SYSTEM, COMMUNICATION TERMINAL DEVICE, AND COMMUNICATION METHOD BETWEEN VEHICLE AND ACCESS POINT

(71) Applicant: Mitsubishi Electric Corporation, Tokyo (JP)

(72) Inventors: Takehara TAKAYOSHI, Tokyo (JP); Eri KUWAHARA, Tokyo (JP)

(73) Assignee: Mitsubishi Electric Corporation, Tokyo (JP)

(21) Appl. No.: 18/474,462

(22) Filed: Sep. 26, 2023

(30) Foreign Application Priority Data
Nov. 24, 2022 (JP) 2022-187042

(51) Int. Cl. H04W 40/20; H04W 40/16

(52) U.S. Cl. CPC H04W 40/205; H04W 40/16

(57) ABSTRACT

When a tall vehicle stops near an access point, reception of application information from the access point may be hindered. Calculation as to whether or not a radio wave from the access point is blocked by an obstacle such as a tall vehicle is performed on the basis of obstacle information created by the access point. If the radio wave is blocked, connection to another access point around the access point from which the radio wave is blocked is searched for.

### BACKGROUND OF THE INVENTION

### 1. Field of the Invention

The present disclosure relates to a communication system, a communication terminal device, and a communication method between a vehicle and an access point.

### 2. Description of the Background Art

Conventionally, in order to cope with fluctuations of a communication environment in wireless LAN communication due to movement of a user having a wireless LAN terminal, an application program is distributed to a terminal device via a base station in which communication with the terminal device has been established, and information on an event that is implemented by executing the application program is distributed to each base station. Also, a communication system that maintains communication between the terminal device and the base station during the event executed by the application program has been known (e.g., see Patent Document 1).
Patent Document 1: WO2019/176519

However, for example, when a tall vehicle stops near an access point communicating application information, the tall vehicle interrupts communication between the access point transmitting application information and a vehicle receiving the application information, the communication in service is interrupted, and thus the vehicle is hindered from receiving the application information.

### SUMMARY OF THE INVENTION

The present disclosure has been made in order to solve the above-described problem, and an object of the present disclosure is to provide a communication system, a communication terminal device, and a communication method between a vehicle and an access point, with which a vehicle is not hindered from receiving application information by an obstacle around an access point, even if the access point does not have high-speed roaming.

A communication system according to the present disclosure includes: a roadside unit arranged along a road and including a sensor unit that senses an obstacle therearound, a sensor information processing unit that converts information sensed by the sensor unit into data, and an access point that creates obstacle information representing at least a position and a height of the obstacle on the basis of sensor information converted into data by the sensor information processing unit and transmits the obstacle information to a vehicle; and a vehicle terminal device that is mounted to the vehicle and is sequentially connected to the access points of the roadside units along a travel route of the vehicle, to acquire the obstacle information from the access points. The vehicle terminal device has an access point selection unit that performs calculation as to whether or not a radio wave from the access point is blocked by the obstacle on the basis of the obstacle information and that, if it is determined that the radio wave is blocked, searches for connection to another access point around the access point from which the radio wave is blocked.

In a communication system of the present disclosure, a vehicle is not hindered from receiving application information by an obstacle around an access point.

### BRIEF DESCRIPTION OF THE DRAWINGS

FIG. 1 is a function block diagram illustrating a communication system according to the first embodiment of the present disclosure;

FIG. 2 is a function block diagram of a roadside unit according to the first embodiment;

FIG. 3 illustrates a conversion of obstacle information by a sensor information processing unit into data according to the first embodiment;

FIG. 4 is a function block diagram of an access point according to the first embodiment;

FIG. 5 illustrates one example of a hardware configuration of the access point according to the first embodiment;

FIG. 6 is a function block diagram of a vehicle terminal device according to the first embodiment;

FIG. 7 illustrates one example of a hardware configuration of the vehicle terminal device according to the first embodiment;

FIG. 8 illustrates a sequence of a communication system according to the first embodiment;

FIGS. 9A to 9D illustrate states on a road in the sequence of the communication system according to the first embodiment; and

FIG. 10 is a flowchart illustrating a procedure when an access point selection determination processing unit selects an access point according to the first embodiment.

### DETAILED DESCRIPTION OF THE PREFERRED

### Embodiments of the Invention

Hereinafter, a preferred embodiment of a communication system according to the present disclosure will be described with reference to the drawings. The same components and corresponding parts are denoted by the same reference characters, and detailed descriptions thereof will be omitted.

### First Embodiment

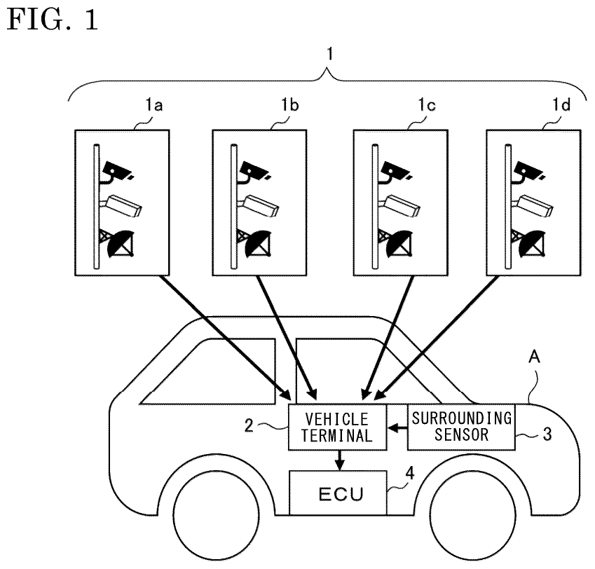

FIG. 1 is a function block diagram of a communication system according to the first embodiment. In this system, a roadside unit 1 provided around a road and including sensors, and a vehicle terminal device 2 mounted to a vehicle A are connected with each other by communication. Although the roadside unit 1 will be described as four roadside units 1a, 1b, 1c, 1d provided on a road around a building, the shape of the road and the number of roadside units are not limited thereto.

### [Configuration of Roadside Unit]

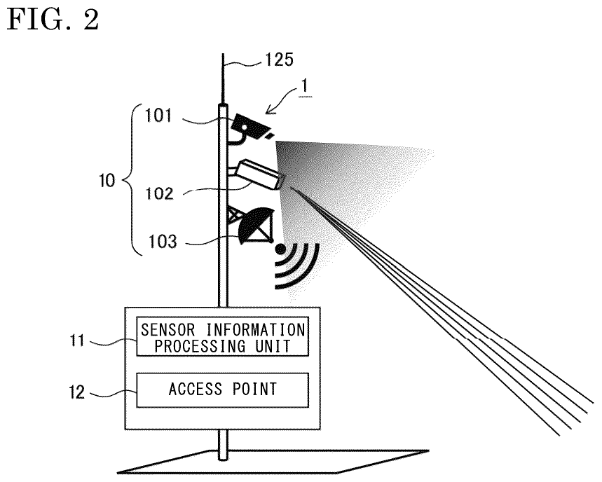

As shown in FIG. 2, the roadside unit 1 includes a sensor unit 10, a sensor information processing unit 11, an access point 12, and an antenna 125 for communication. For example, the sensor unit 10 is for sensing a vehicle, a pedestrian, etc., and includes an image recognition camera 101, a light detection and ranging (LiDAR) unit 102, and a millimeter-wave radar 103. The types of the sensors are examples, and are not limited thereto. The sensor units, the access points, and other units of the roadside units 1a to 1d will be described as sensor units 10a to 10d, access points 12a to 12d, and the like to which a to d are added, respectively.

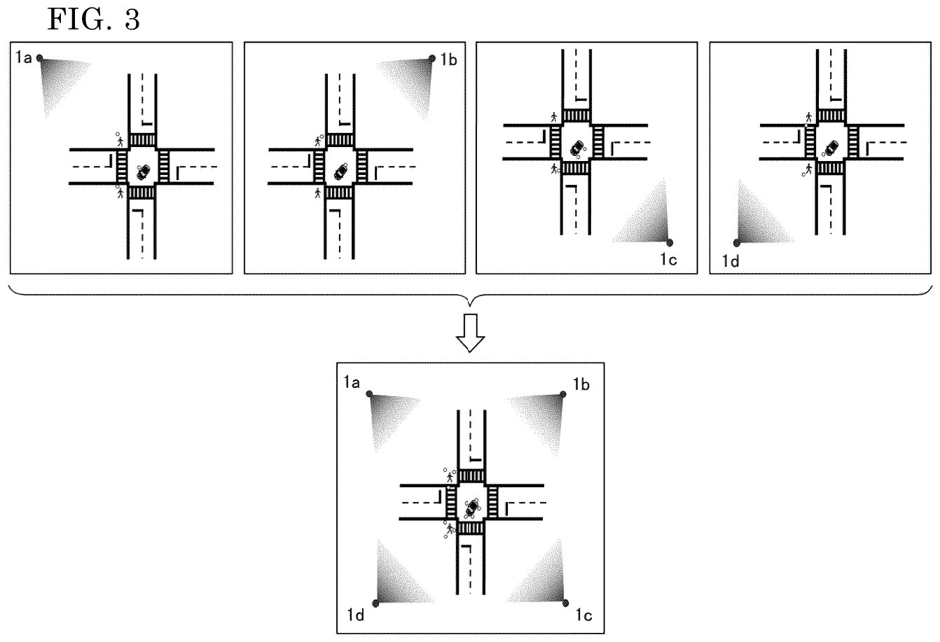

The sensor information processing unit 11 receives a sensing result sensed by the sensor unit 10 and performs processing to convert sensor information around the roadside unit 1 into data. For example, as shown in FIG. 3, the sensor information from sensing points sensed by LiDAR units 102a to 102d of the roadside units 1a to 1d that are respectively provided in four places on a road around a building is shown by circles, and a result obtained by collecting the sensor information of the four LiDAR units is shown at the lower part of FIG. 3. The sensing points pointing to the same object may be combined into one sensing point showing one piece of sensor information. In addition, in order to improve the accuracy, the sensor information by the sensing points of the image recognition camera 101 and the millimeter-wave radar 103 may also be mapped and integrated on one map in the same manner. The sensor information processed as above is transmitted to the access point 12. In FIG. 3, hatching drawn so as to be emitted from each of the roadside units 1a to 1d schematically shows spreading of an area that can be sensed by the LiDAR unit 102.

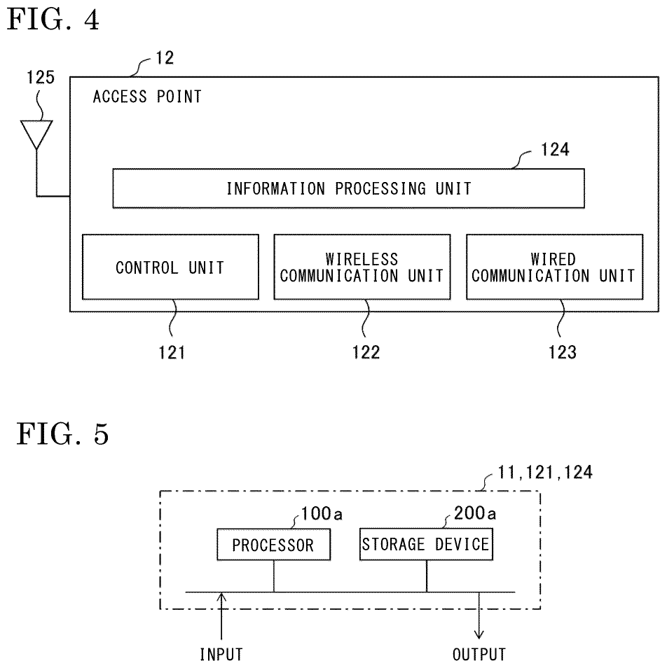

The access point 12 receives the data-converted sensor information from the sensor information processing unit 11, and creates obstacle information on the basis of the sensor information. Examples of the obstacle information include the kind of the sensed sensor information (vehicle, pedestrian, etc.), and a location of the sensed obstacle on a road. When the sensed obstacle is a vehicle, examples of the obstacle information include the width, the length, the height, the type (passenger car, truck, station wagon, or the like), and the characteristics (vehicle having gull-wing doors, hook and ladder truck, or crane truck) of the vehicle. FIG. 4 is a function block diagram of the access point 12. The access point 12 includes a control unit 121, a wireless communication unit 122, a wired communication unit 123, an information processing unit 124, and an antenna 125.

The control unit 121 controls the entire access point 12. The wireless communication unit 122 is controlled by the control unit 121, and communicates with the vehicle terminal device 2 through an operational channel of a predetermined radio band via the antenna 125 according to a predetermined protocol.

The wired communication unit 123 is controlled by the control unit 121, and communicates with an access point 12 provided in another roadside unit 1 through a predetermined wired channel according to a predetermined protocol to receive/transmit information.

The information processing unit 124 may create the obstacle information from the data-converted sensor information received from the sensor information processing unit 11, and may transmit the created obstacle information through the wired communication unit 123 to all the access points 12 present on a driving route of the vehicle A. Accordingly, all the access points 12 disposed on the driving route can share the obstacle information on the entire driving route with each other. According to the relationship between the storage capacity and the processing time, the obstacle information in an area up to the access point 12 that is several access points 12 ahead on the predicted travel route may be shared. The obstacle information may be updated at predetermined time intervals.

In addition, the information processing unit 124 transmits the obstacle information created in the access point 12 and obstacle information in access points 12 present on the driving route, to the vehicle terminal devices 2 of the vehicles around the access point 12 via the wireless communication unit 122. Although the access point 12 and the sensor information processing unit 11 are shown as different functions in the present embodiment, the information processing unit 124 of the access point 12 may have the function of the sensor information processing unit 11, so that the information processing unit 124 may convert a sensing result into data and create the obstacle information.

Some of the functions of the access point 12 may be implemented by dedicated hardware, and some of the functions of the access point 12 may be implemented by software or firmware. Furthermore, the above function of each unit may be implemented by hardware, software, firmware, or a combination thereof.

One example of hardware of a microcomputer in each of the sensor information processing unit 11, the control unit 121, and the information processing unit 124 is shown in FIG. 5. The microcomputer is composed of a processor 100a and a storage device 200a. Although not shown, the storage device 200a includes a volatile storage device such as a random access memory, and a nonvolatile auxiliary storage device such as a flash memory. The storage device 200a may include an auxiliary storage device such as a hard disk, instead of a flash memory. The processor 100a executes a program inputted from the storage device 200a so that the sensor information is converted into data, the obstacle information is created, etc., for example, as described above. In this case, the program is inputted to the processor 100a via the volatile storage device from the auxiliary storage device. The processor 100a may output data such as a calculation result to the volatile storage device of the storage device 200a, or store such data into the auxiliary storage device via the volatile storage device.

### [Configuration in Vehicle]

Regarding the configuration in the vehicle, the vehicle terminal device 2 and a surrounding sensor 3 are connected to an electronic control unit (ECU) 4, for example, as shown in FIG. 1.

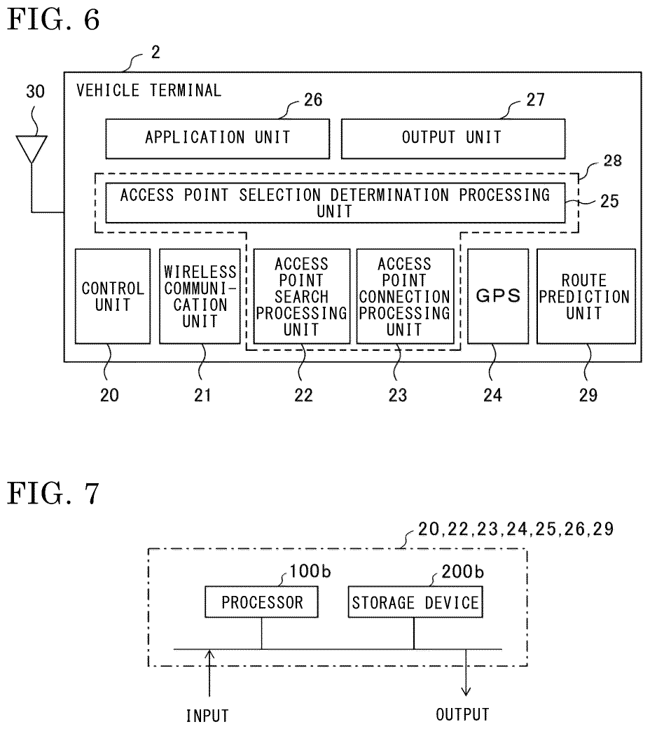

For example, as shown in FIG. 6, the vehicle terminal device 2 includes a control unit 20, a wireless communication unit 21, an access point search processing unit 22, an access point connection processing unit 23, a global positioning system (GPS) 24, an access point selection determination processing unit 25, an application unit 26, an output unit 27, a route prediction unit 29, and an antenna 30.

The control unit 20 controls the entire operation of the vehicle terminal device 2. The wireless communication unit 21 is controlled by the control unit 20, and communicates with the access point 12 through an operational channel of a predetermined radio band via the antenna 30 according to a predetermined protocol.

The access point search processing unit 22 searches access points therearound and distributes a search result to the access point selection determination processing unit 25. Accordingly, the vehicle A can obtain information on the wireless communication area of each access point 12, and thus determine whether or not the vehicle is within the wireless communication area of the access point 12 in the case of performing autonomous driving, for example. In addition, the information on the wireless communication area of each access point may be stored in advance as a database in the access point search processing unit 22, and the wireless communication areas in the database may be searched using vehicle position information. The access point connection processing unit 23 performs a connecting process to the selected access point 12.

The GPS 24 acquires a signal from a satellite, which is not shown, to obtain an own position as position information on earth, and distributes the position information to the access point selection determination processing unit 25. Here, a configuration other than the GPS 24 may be used as long as an own position can be obtained.

The application unit 26 acquires, stores, and executes application information distributed via the access point connected by the access point connection processing unit 23. In the present embodiment, the application information corresponds to the above-described obstacle information.

The access point selection determination processing unit 25 selects an access point to be connected on the basis of the search result of the access points distributed from the access point search processing unit 22, the communication area of each access point, a radio wave intensity, the obstacle information created in each access point and maintained by the application unit 26, and a prediction result of the route prediction unit 29, and outputs a selection result to the access point connection processing unit 23. The access point selection determination processing unit 25, the access point connection processing unit 23, and the access point search processing unit 22 are collectively referred to as an access point selection unit 28.

The output unit 27 is composed of a display device for displaying images of the application information maintained by the application unit 26 inside the vehicle, a loudspeaker for outputting sounds, etc., and performs reporting by outputting the images and the sounds in the vehicle.

The route prediction unit 29 predicts a driving route of the vehicle from information such as self-position information on latitude/longitude from the GPS 24, the speed of the vehicle, an angle of a steering wheel during driving, an output of a direction indicator, and in the case of autonomous driving, a route schedule in an autonomous driving area stored in advance.

Some of the functions of the vehicle terminal device 2 may be implemented by dedicated hardware, and some of the functions of the vehicle terminal device 2 may be implemented by software or firmware. Furthermore, the above function of each unit may be implemented by hardware, software, firmware, or a combination thereof.

FIG. 7 shows one example of hardware of a microcomputer that operates each of the control unit 20, the access point search processing unit 22, the access point connection processing unit 23, the GPS 24, the access point selection determination processing unit 25, the application unit 26, and the route prediction unit 29. The microcomputer is composed of a processor 100b and a storage device 200b. Although not shown, the storage device 200b includes a volatile storage device such as a random access memory, and a nonvolatile auxiliary storage device such as a flash memory. The storage device 200b may include an auxiliary storage device as a hard disk, instead of a flash memory. The processor 100b executes operation of each unit of the above vehicle terminal device 2 according to a program inputted from the storage device 200b. In this case, the program is inputted to the processor 100b via the volatile storage device from the auxiliary storage device. The processor 100b may output data such as a calculation result to the volatile storage device of the storage device 200b, or store such data into the auxiliary storage device via the volatile storage device.

Although a component representative of the surrounding sensor 3 mounted to the vehicle shown in FIG. 1 is an entire-circumference laser radar, the surrounding sensor 3 may be an image recognition camera that can view the entire area around the vehicle. Alternatively, the surrounding sensor 3 may be a millimeter-wave radar or an ultrasonic sensor.

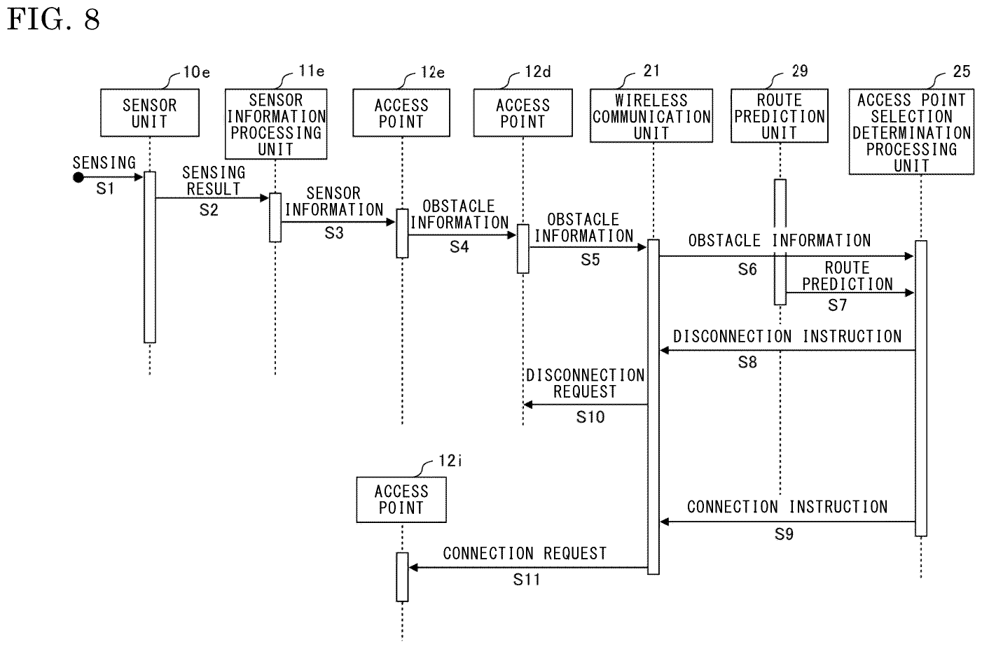

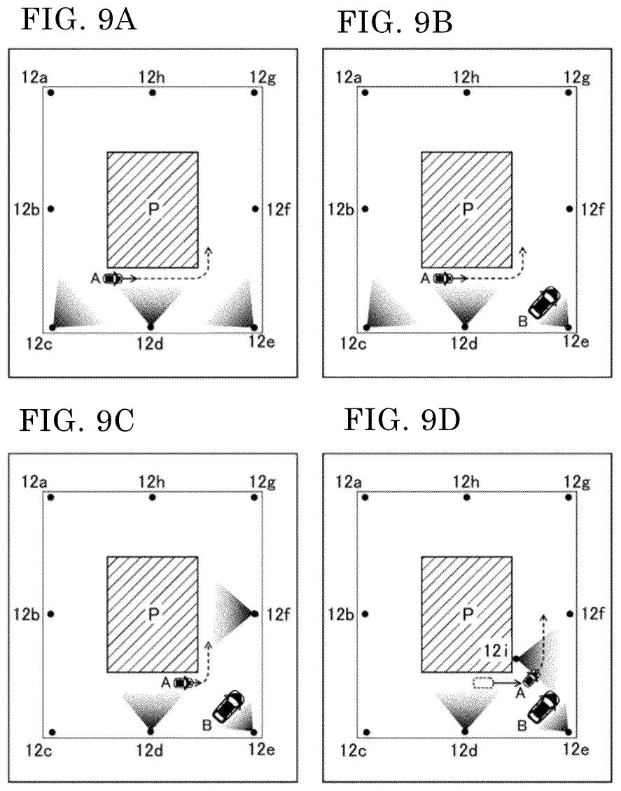

With reference to FIG. 8 and FIG. 9A to 9D, operation of the communication system of the present embodiment will be described. FIG. 8 illustrates a sequence of the communication system, and FIGS. 9A to 9D each illustrate a state of the sequence in FIG. 8. The sensor units, the access points, and other units of the roadside units 1a to 1h will be described as the sensor units 10a to 10h, the access points 12a to 12h, and the like to which a to h are added, respectively.

In FIG. 3, the roadside units 1a to 1d are used for illustration. In FIG. 9A to 9D, on the assumption that the roadside units 1a to 1h are disposed, the description is provided. The sensor units 10a to 10h of the roadside units 1a to 1h acquire sensing results with respect to obstacles therearound, and transmit the sensing results to the sensor information processing units 11a to 11h, respectively. Each of the sensor information processing units 11a to 11h converts the obstacle therearound into data as sensor information by using the sensing result. The data-converted sensor information is transmitted from the sensor information processing units 11a to 11h to the access points 12a to 12h, respectively. The access points 12a to 12h create obstacle information on the basis of the sensor information. The obstacle information is transmitted from the wired communication units 123a to 123h of the access points 12a to 12h to each of the access points 12a to 12h. Accordingly, the access points 12a to 12h share all the obstacle information present on a driving route at that point with each other. The obstacle information is updated at predetermined time intervals.

For example, as shown in FIG. 9A, the vehicle A travels along a travel route going around a building P in an arrow direction through autonomous driving. A radio wave intensity from the access point 12c of the roadside unit 1c acquired by the access point search processing unit 22 of the vehicle terminal device 2 decreases along with the advance of driving. Thus, connection with the access point 12c is disconnected, and connection to the access point 12d having the greatest radio wave intensity to the vehicle A is established to acquire obstacle information. Hatching from each of the access points 12c, 12d, 12e schematically shows a range to which the radio wave of the access point propagates. The hatchings from access points, which are not described, other than the access points 12c, 12d, 12e are omitted.

It is predicted that the connection to the access point 12d is followed by connection to the access point 12e. However, as shown in FIG. 9B, the sensor unit 10e provided in the roadside unit 1e of the access point 12e senses that a vehicle B taller than the vehicle A is parked between the access point 12e and the vehicle A (step S1 in FIG. 8). The sensing result is transmitted to the sensor information processing unit 11e (step S2). The sensor information processing unit 11e processes the received sensing result to convert the vehicle B into data as sensor information. The data-converted sensor information is inputted from the sensor information processing unit 11e to the access point 12e (step S3), and the information processing unit 124e creates, from the sensor information, obstacle information on the vehicle B including the position on a road, the width, the length, the height, the type, the characteristics, and the like of the vehicle B. The obstacle information is transmitted from the wired communication unit 123e to other access points 12a to 12d and 12f to 12h (step S4). Upon receiving the obstacle information on the vehicle B from the access point 12e, the access point 12d connected to the vehicle A transmits the obstacle information to the wireless communication unit 21 of the vehicle A (step S5). The obstacle information on the vehicle B received by the wireless communication unit 21 is transmitted to the access point selection determination processing unit 25 (step S6). Furthermore, a predicted route of the vehicle A from the route prediction unit 29 is transmitted to the access point selection determination processing unit 25 (step S7).

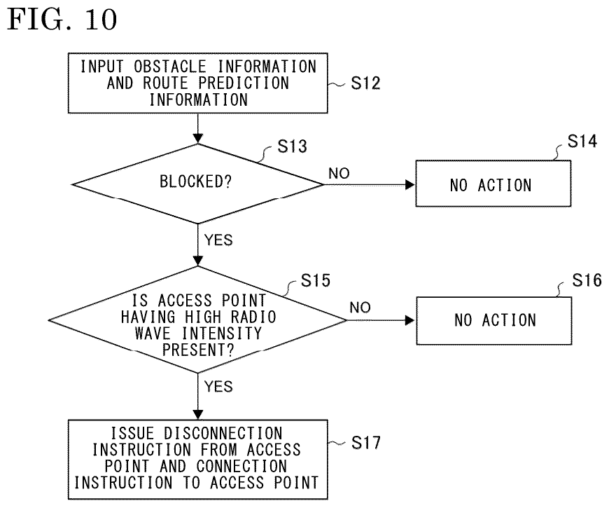

The access point selection determination processing unit 25 selects an access point to be connected according to a flowchart shown in FIG. 10, for example.

In FIG. 10, the obstacle information on the vehicle B is inputted to the access point selection determination processing unit 25 (step S12 in FIG. 10). When the vehicle A is found to be scheduled to travel around the access point 12e from the predicted route of the vehicle A, calculation as to whether or not connection between the access point 12e and the vehicle A is blocked by the vehicle B is performed on the basis of the obstacle information on the vehicle B (step S13). The calculation may be performed by comparing the position, the length, and the height of the vehicle B obtained from the obstacle information with those of the vehicle A maintained by the application unit of the vehicle terminal device 2. Alternatively, from the characteristics of the type of the vehicle B obtained from the obstacle information, when the vehicle B has a part that moves to a height higher than the height of the vehicle B, for example, when the vehicle B has doors that spring in a manner of wing-motion, the height and the length of the part of the vehicle B may be compared with those of the vehicle A.

As a result of the calculation, if the connection with the access point 12e is not blocked by the vehicle B, the process ends without taking any action and the connection is switched from the access point 12d to the access point 12e at a predetermined timing along operation of autonomous driving (step S14). If it is determined that the connection with the access point 12e is blocked by the vehicle B, a search as to whether or not an access point having a radio wave intensity higher than that of the access point 12d or a radio wave intensity higher than a predetermined threshold is present around the access point 12e is performed (step S15). In this case, a database of an electric field intensity of each access point stored in advance in the vehicle A may be referred to. If the access point having the radio wave intensity higher than that of the access point 12d or the radio wave intensity higher than the predetermined threshold cannot be found (see FIG. 9C), the process ends without taking further action and the autonomous driving is switched to manual driving (step S16). Alternatively, the autonomous driving is continued along the travel route while the surrounding sensor 3 mounted to the vehicle performs obstacle detection around the vehicle, and the connection is performed when the next access point 12f having a high radio wave intensity is found.

In the case where an access point 12i is found, as an access point having the radio wave intensity higher than the predetermined threshold, that is, a radio wave intensity sufficient for communication, the access point selection determination processing unit 25 selects the access point 12i and issues a disconnection instruction from the access point 12d (step S8 in FIG. 8, step S17 in FIG. 10) and a connection instruction to the access point 12i (step S9 in FIG. 8, step S17 in FIG. 10). A disconnection request is transmitted from the access point connection processing unit 23 via the wireless communication unit 21 to the access point 12d (step S10 in FIG. 8), and a connection request is transmitted to the access point 12i (step S11 in FIG. 8). Accordingly, as shown in FIG. 9D, the access point 12i and the vehicle terminal device 2 are connected with each other, and application information is acquired from the wireless communication unit 1221 of the access point 12i, whereby a service for transmitting the obstacle information to the vehicle A can be continued without interrupting communication.

In the above description, selection determination of the access point is performed by the vehicle side. However, the determination may be performed by the roadside unit. In this case, information other than the obstacle information that is converted into data by the roadside unit, for example, information (information on the position on a road, the width, the length, the height, the type, and the characteristics of the vehicle, a radio wave intensity, etc.) that is about the vehicle predicted to be connected to the access point 12 and is to be compared with the obstacle, route prediction information, and the like may be transmitted from the vehicle terminal device 2 to the access point 12 of the roadside unit 1.

In addition, the sensor unit 10 and the sensor information processing unit 11 provided in the roadside unit may be mounted to the vehicle. In this case, the sensor units mounted to a plurality of the vehicles traveling on a travel route sense an obstacle around each access point, sensing results are converted into data in the sensor information processing units mounted to the vehicles, and the data-converted sensor information is transmitted from the wireless communication units 21 to the access points around the vehicle. Each access point creates obstacle information on the basis of the received sensor information, and all the obstacle information created by the access points on the travel route is shared. The following process is the same as that after the above described step S5.

For example, when a tall vehicle B stops around the access point 12d in a state in which the vehicle A and the access point 12d are connected with each other, the sensor unit 10d may sense the vehicle B (step S1), a sensing result may be converted into data as sensor information in the sensor information processing unit 11d (step S3), obstacle information may be created in the access point 12d (step S4), and the obstacle information may be transmitted to the wireless communication unit of the vehicle A. In this case, on the basis of the received obstacle information, calculation as to whether or not connection between the access point 12d and the vehicle A is blocked by the vehicle B is performed in the access point selection determination processing unit 25 on the basis of the obstacle information (step S13). If it is determined that the connection is blocked, a search as to whether or not an access point having a radio wave intensity higher than that of the access point 12d or a radio wave intensity higher than a predetermined threshold is present around the access point 12d is performed (step S15). When such an access point is found, step S8 to step S11 are performed as in the above.

As described above, according to the present embodiment, even if the access point does not have high-speed roaming, calculation as to whether or not a radio wave from the access point is blocked by an obstacle is performed on the vehicle side on the basis of obstacle information. If it is determined that the radio wave is blocked, connection to another access point around the access point from which the radio wave is blocked is searched for and switching of the access points is performed, whereby communication interruption of application information to be transmitted from the access point can be eliminated.

Although the disclosure is described above in terms of an exemplary embodiment, it should be understood that the various features, aspects and functionality described in the embodiment are not limited in their applicability to the particular embodiment with which they are described, but instead can be applied, alone or in various combinations, to the embodiment of the disclosure.

It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

1 roadside unit
2 vehicle terminal device
3 surrounding sensor
4 ECU
10 sensor unit
11 sensor information processing unit
12 access point
20 control unit
21 wireless communication unit
22 access point search processing unit
23 access point connection processing unit
24 GPS
25 access point selection determination processing
unit
26 application unit
27 output unit
28 access point selection unit
29 route prediction unit
30 antenna
100a, 100b processor
121 control unit
122 wireless communication unit
123 wired communication unit
124 information processing unit
125 antenna
200a, 200b storage device

What is claimed is:

1. A communication system comprising:
a roadside device arranged along a road, and including
a sensor that senses an obstacle therearound,
a sensor information processing circuitry that converts information sensed by the sensor into data, and
an access point that creates obstacle information representing at least a position and a height of the obstacle on the basis of sensor information converted into data by the sensor information processing circuitry and transmits the obstacle information to a vehicle; and
a vehicle terminal device that is mounted to the vehicle and is sequentially connected to the access points of the roadside device along a travel route of the vehicle, to acquire the obstacle information from the access points, wherein
the vehicle terminal device includes an access point selector that performs calculation as to whether or not a radio wave from the access point is blocked by the obstacle on the basis of the obstacle information and that, if it is determined that the radio wave is blocked, searches for connection to another access point around the access point from which the radio wave is blocked.

2. The communication system according to claim 1, wherein
the vehicle terminal device further includes a route predictor that predicts a travel route of the vehicle,
calculation as to whether or not a radio wave is blocked by an obstacle around the access point predicted to be connected on the predicted travel route is performed on the basis of the obstacle information, and
if it is determined that the radio wave is blocked, connection to another access point around the access point from which the radio wave is blocked is searched for.

3. The communication system according to claim 1, wherein
the access points of the roadside device arranged along the travel route are connected with each other, and share the obstacle information created by the access points with each other.

4. A communication terminal device comprising:
a wireless communicator that is sequentially connected to access points disposed on a roadside along a travel route of a vehicle and acquires obstacle information representing at least a position and a height of an obstacle around the access point from an access point to which the wireless communicator is connected; and
an access point selector that performs calculation as to whether or not a radio wave from the access point is blocked by the obstacle on the basis of the obstacle information and that, if it is determined that the radio wave is blocked, searches for connection to another access point around the access point from which the radio wave is blocked.

5. The communication terminal device according to claim 4, further comprising a route predictor that predicts the travel route, wherein
the communication terminal device performs calculation as to whether or not a radio wave from the access point predicted to be connected on a predicted travel route is blocked on the basis of the obstacle information and, if it is determined that the radio wave is blocked, searches for connection to another access point around the access point from which the radio wave is blocked.

6. A communication method between a vehicle and an access point, comprising:
sensing an obstacle around an access point predicted to be connected;
converting a sensing result into data;
creating obstacle information on the basis of sensor information converted into data;
performing calculation as to whether or not a radio wave from the access point predicted to be connected is blocked by the obstacle on the basis of information on the obstacle;
if it is determined that the radio wave is blocked, searching for connection to another access point around the access point from which the radio wave is blocked; and
if the other access point having a radio wave intensity not less than a predetermined radio wave intensity is present, transmitting, to a vehicle, a result that the other access point is selected for connection.

7. The communication system according to claim 2, wherein
the access points of the roadside device arranged along the travel route are connected with each other, and share the obstacle information created by the access points with each other.
